(19) United States
(12) Patent Application Publication
(10) Pub. No.: US 2015/0301911 A1
(43) Pub. Date: Oct. 22, 2015

(54) INFORMATION PROCESSING APPARATUS, CONTROL METHOD FOR INFORMATION PROCESSING APPARATUS, AND COMPUTER-READABLE RECORDING MEDIUM

(71) Applicant: FUJITSU LIMITED, Kawasaki-shi (JP)

(72) Inventors: Yoshiaki KIKKAWA, Kawasaki (JP); lkuroh FUJIWARA, Kawasaki (JP)

(73) Assignee: Fujitsu Limited, Kawasaki (JP)

(21) Appl. No.: 14/753,894

(22) Filed: Jun. 29, 2015

Related U.S. Application Data
(63) Continuation of application No. PCT/JP2013/050594, filed on Jan. 15, 2013.

(51) Int. Cl. G06F 11/20

(52) U.S. Cl. CPC G06F 11/2028; G06F 11/203

(57) ABSTRACT

A configuring unit performs configuration of a partition that is a combination of a system board equipped with a central processing unit and a memory, and an input/output unit equipped with an input/output device that are installed in one package, and performs allocation of a reserved system board to the partition. A switching unit switches, when a failed system board in which a failure has occurred is present, the failed system board to a reserved system board that is allocated to a partition including the failed system board. A re-setting unit performs resetting, when the failed system board is recovered after switching of system boards have been performed by the switching unit, based on information of the configuration of the partition and the allocation of the reserved system board made by the configuring unit.

### CROSS-REFERENCE TO RELATED APPLICATION

This application is a continuation of International Application No. PCT/JP2013/050594, filed on Jan. 15, 2013, the entire contents of which are incorporated herein by reference.

### FIELD

The embodiment discussed herein is directed to an information processing apparatus, a control method for an information processing apparatus, and a computer-readable recording medium.

### BACKGROUND

For a server used in a core system, high availability and flexible operation of resources are demanded. For example, as a function to achieve high availability of a system, there is a reserved system board (SB) function.

In a server having the reserved SB function, a backup SB is contained in a package. With the reserved SB function, when a failure occurs in an operating system board, the system board in which the failure has occurred is independently separated, and a backup system board is installed in a short time, and thus the system board in which the failure has occurred is switched to a new system board. The system board is a board in which a central processing unit (CPU) and a memory are equipped. The backup system board to be a subject of switching destination when a failure occurs is called reserved SB.

When the reserved SB function is used, when a hardware failure occurs in a system board, early recovery to the same conditions as before occurrence of the failure is possible without causing reduction of system board resources.

Moreover, as a technique to improve the availability, there is a technique in which one package is divided into multiple logical systems and is used as if multiple servers are equipped therein. Specifically, it is a function in which one package is divided into sets of a system board and an input/output (I/O) unit (hereinafter, this set is referred to as “partition”), and each of partitions obtained by division is operated independently as one logical system. In each of the partitions, software resources such as an operation system (OS) and an application, and hardware resources such as a system board and an I/O unit. In one partition, more than one system board may be included, and more than one I/O unit may be included. Furthermore, in the I/O unit, a hard disk, a network card, and the like are included. As described, if a partition configuration is applied, even if a failure occurs in one partition, the other partitions are not affected thereby.

Moreover, by combining the partition configuration and the reserved SB function described above, a system having higher availability can be structured.

For example, multiple partitions are created in one package and used as an operation system, and a system board and an I/O unit that are not structured as a partition is used as a standby system. To the system board of the operation system, a reserved SB that is a system board to be switched to is allocated. This reserved SB may be a system board in the standby system, or may be one of system boards when more than one system board is included in a partition other than the partition including the system board to which the reserved SB is allocated. When a trouble occurs in a system board in one partition, the operation of the partition can be continued by switching to the reserved SB that is allocated to the failed system board. For example, when the reserved SB is a system board included in the other partition, it may be considered to continue the operation by separating the reserved SB from the partition, and switching a system board thereto from the failed system board.

In a system in which the partition configuration and the reserved SB function are thus combined, if replacement of the failed system board is done in maintenance after switching of system boards has happened, it may be considered to return back to a partition configuration before the failure occurs. This is because of the following reasons. First, it can be preferable to operate a system in a structure of an operation policy initially set. For example, when multiple packages structure partitions in the same operation policy, if only a package in which a trouble has occurred has a different structure, there is an inconvenience in management. Furthermore, it may be considered that a backup system board used as the reserved SB is a temporary substitute to enable recovery in a short time, and does not have sufficient specifications for continuous use. Furthermore, when a system board is switched to a system board in the other partition, a state in which the performance of the other partition is lowered may continue.

As a conventional technique relating to changes of a system configuration, a technique has been available in which when there is a change in a system configuration from the time of activation, and if a system configuration after the change is a configuration that has been applied previously, information relating to the system configuration is not regenerated and information of the previous information is used (for example, Japanese Laid-open Patent Publication No. 5-108534).

However, when the partition configuration and the reserved SB function are simply combined, the setting information of the reserved SB and the configuration information of partitions do not remain after switching of system boards occurs. Therefore, the administrator has been performing processing as follows to repair the failed system board and to restore to the partition configuration before the occurrence of the failure. First, the administrator acquires setting information of a reserved SB and configuration information of partitions by analyzing system event logs, and the like. The administrator then uses the acquired information to install the repaired system board into the original partition. Furthermore, the administrator performs re-setting of the reserved SB so as to bring back to the setting before occurrence of the failure. By performing the above processing, it is possible to return it to the state before occurrence of the failure.

As described, going through all the analysis of system event logs, reconfiguration of partitions, and re-setting of a reserved SB is complicated, and there is a possibility of inducing a human error.

Moreover, in the conventional technique in which previous information is used as information related to a system configuration, a configuration of partitions is not considered, and it has been difficult to reconfigure partitions and to perform re-setting of a reserved SB automatically after recovery from a failure.

### SUMMARY

According to an aspect of an embodiment, an information processing apparatus includes: a configuring unit that performs configuration of a partition and allocation of a reserved system board to the partition, the partition being a set of a system board equipped with a central processing unit and a memory, and an input/output unit equipped with an input/output device that are installed in one package; a switching unit that switches, when a failed system board in which a failure has occurred is present, the failed system board to a reserved system board that is allocated to a partition including the failed system board; and a re-setting unit that resets, when the failed system board is recovered after switching of system boards have been performed by the switching unit, the configuration of the partition and the allocation of the reserved system board based on information of the configuration of the partition and the allocation of the reserved system board made by the configuring unit.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a configuration diagram of an information processing system according to an embodiment;

FIG. 2 is a block diagram of a server management device;

FIG. 3 illustrates one example of a partition configuration;

FIG. 4 illustrates one example of partition configuration information;

FIG. 5 is a diagram for explaining system board switching by a reserved SB function;

FIG. 6 illustrates one example of post-switch information;

FIG. 7 illustrates one example of post-switch information when a failure occurs in two system boards;

FIG. 8 is a flowchart of configuration of a partition and setting of a reserved SB in the information processing system according to the embodiment;

FIG. 9 is a flowchart of processing of the reserved SB function in the information processing system according to the embodiment;

FIG. 10 is a flowchart of processing of failure recovery in the information processing system according to the embodiment; and

FIG. 11 is a hardware configuration diagram of the server management device.

### DESCRIPTION OF EMBODIMENT(S)

An embodiment of an information processing apparatus, a control method for an information processing apparatus, and a computer-readable recording medium for controlling an information processing apparatus disclosed in the present application is explained in detail below with reference to the accompanying drawings. The information processing apparatus, the control method for an information processing apparatus, and the computer-readable recording medium for controlling an information processing apparatus disclosed in the present application are not limited by the following embodiment.

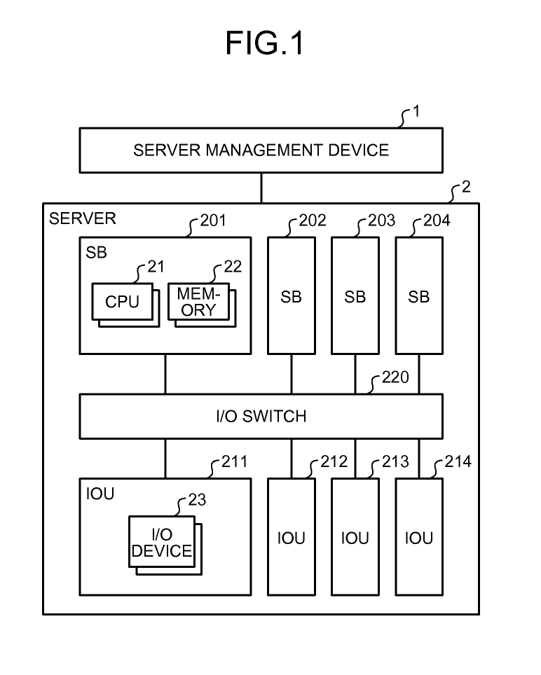

FIG. 1 is a configuration diagram of an information processing system according to the present embodiment. As illustrated in FIG. 1, the information processing system according to the embodiment includes a server management device 1 and a server 2. Although only one unit of the server 2 is depicted in the present embodiment, the server management device 1 can manage more than one unit of the server 2 at the same time.

The server 2 includes system boards 201 to 204, an input/output (I/O) switch 220, and input output units (IOU) 211 to 214.

Each of the system boards 201 to 204 has a CPU 21 and a memory 22. In the drawing, the system board is expressed as “SB” to make them easy to follow. In the present embodiment, each of the system boards 201 to 204 has more than one unit of the CPU 21 and the memory 22. Moreover, although the present embodiment is explained with a configuration in which the four system boards 201 to 204 are equipped in the server 2, the number of system boards is not limited thereto as long as more than one system board is included. Hereinafter, the system boards 201 to 204 are referred to simply as “system board 200” when each of the system boards 201 to 204 is not distinguished.

The IOU 211 to 214 are devices on which an I/O device 23, such as a hard disk drive and a peripheral component interconnect (PCI) card, is mounted. Hereinafter, the IOU 211 to 214 are referred to simply as “IOU 210” when each of the IOU 211 to 214 is not distinguished.

The I/O switch 220 is a switch that connects the system board 200 and the IOU 210. The I/O switch 220 is switched to connect a specific system board to a specific IOU, thereby connecting the CPU 21 on the specific system board and the I/O device 23 on the specific IOU through a bus. Thus, the CPU 21 is enabled to use the I/O device on the connected IOU. For example, when the I/O switch 220 is switched to connect the system board 201 and the IOU 211, the CPU 21 on the system board 201 is enabled to use the I/O device 23 on the IOU 211.

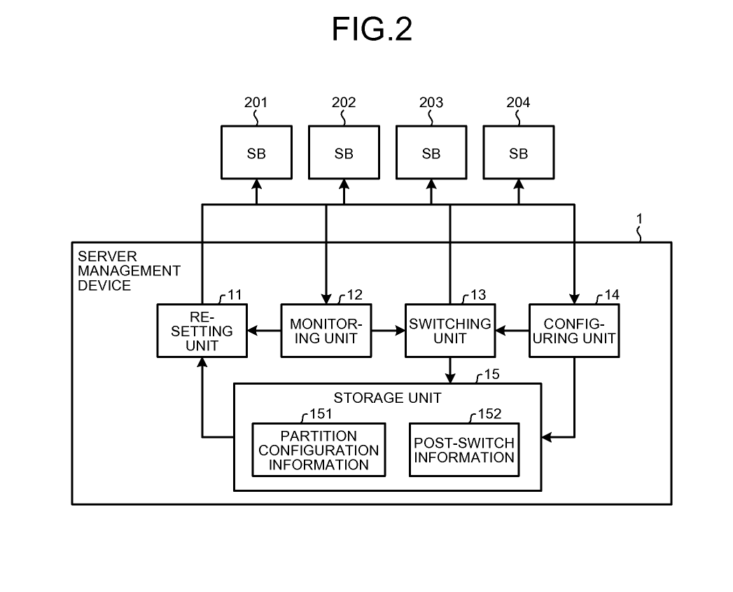

The server management device 1 performs management of the server 2 such as configuration of the server 2 based on an instruction from an administrator and restoration from a failure of the server 2 when a failure occurs. The server management device 1 is connected to each of the respective system boards 200, the I/O switch 220, and the respective IOUs 210. In FIG. 1, connection is collectively expressed as the server management device 1 and the server 2 are connected to make them easy to understand. Next, referring to FIG. 2, the server management device 1 is explained in detail. FIG. 2 is a block diagram of the server management device.

As illustrated in FIG. 2, the server management device 1 according to the present embodiment includes a re-setting unit 11, a monitoring unit 12, a switching unit 13, a configuring unit 14, and a storage unit 15.

The storage unit 15 is a non-volatile storage unit, and is, for example, a non-volatile random access memory (NVRAM) and the like.

The configuring unit 14 receives an input of partition configuration information, reserved SB information, and an instruction for automatic recovery from an administrator. For example, the administrator inputs partition configuration information, reserved SB information, and an instruction for automatic recovery, by using a terminal that is connected to the server management device 1 through a user interface (not illustrated) of the server management device 1 or a network. The partition configuration information includes information indicating which out of the system boards 200 and which out of the IOU 210 are brought into a set. Furthermore, the reserved SB information includes information of a system board (hereinafter, “reserved SB”) to be switched to by the reserved SB function when a failure occurs in the system board 200 included in each partition. Moreover, the instruction of automatic recovery includes an instruction whether to return back to a configuration before switch when an action to a failure such as repair or replacement of the system board 200 in which the failure has occurred is taken after switching of the system boards 200 is performed by the reserved SB function. The configuring unit 14 configures the system board 200, the I/O switch 220, and the IOU 210 so as to have the partition configuration instructed by the administrator and the specified reserved SB. Furthermore, when an instruction to perform automatic recovery is received, the configuring unit 14 turns on an automatic recovery flag in the storage unit 15. For example, as the automatic recovery flag, a predetermined bit in the storage unit 15 can be used. Moreover, the configuring unit 14 informs the switching unit 13 of the information about the partition configuration and setting of the reserved SB.

For example, in the present embodiment, the configuring unit 14 receives input of partition configuration information indicating that the system board 201 and the IOU 211 constitutes one partition, and the system board 202 and the IOU 212 constitutes one partition as partition configuration. Moreover, the configuring unit 14 receives input of information indicating that the system board 203 and the system board 204 are the reserved SBs of the system board 201 of a partition 301, as the reserved SB information. Furthermore, the configuring unit receives information indicating that the system board 203 and the system board 204 are the reserved SBs of the system board 202 of a partition 302, as the reserved SB information.

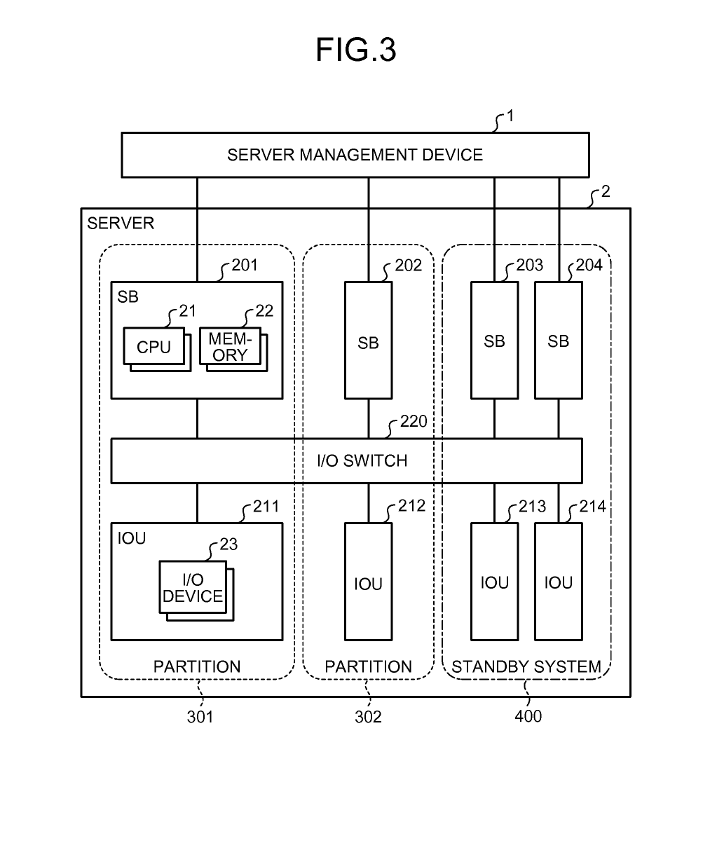

FIG. 3 illustrates one example of a partition configuration. In this case, the configuring unit 14 configures the partition 301 with the system board 201 and the IOU 211 as illustrated in FIG. 3. For example, the configuring unit 14 controls the I/O switch 220 to connect the system board 201 and the IOU 211. Moreover, the configuring unit 14 instructs the CPU 21 of the system board 201 to use only the I/O device 23 of the IOU 211. Similarly, the configuring unit 14 configures the partition 302 with the system board 202 and the IOU 212. The system boards 203 and 204, and the IOUs 213 and 214 are not allocated to elements to constitute a partition. The system boards and the IOUs that are not allocated to a partition do not perform processing. In this state, the system boards 203 and 204, and the IOUs 213 and 214 are devices that are not used for operation. That is, the respective devices that are allocated to the partitions 301 and 302 belong to an operation system that is used for actual operation, while the devices surrounded by a long and short dashed line expressed as a standby system 400 are devices belonging to a standby system. The devices included in the standby system 400 can operate as a substitute of a failed device, for example, when a failure occurs in a device in the operation system. Furthermore, the configuring unit 14 stores that the system board 203 and the system board 204 are the reserved SBs of the system board 201 and the system board 202. Hereinafter, the partition 301 and the partition 302 are referred to simply as “partition 300” when not distinguished.

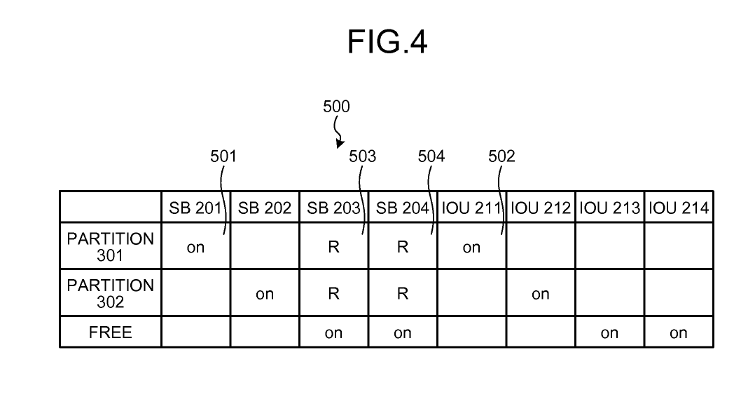

Moreover, the configuring unit 14 creates a table using the partition configuration information input by the administrator according to a predetermined format, and stores in the storage unit 15 as partition configuration information 151. For example, in the present embodiment, the configuring unit 14 creates a table 500 in FIG. 4, and stores the created table 500 in the storage unit 15 as the partition configuration information 151. FIG. 4 illustrates one example of the partition configuration information.

The partition configuration information represented in FIG. 4 is explained. In fields at the left end, information of respective partition is indicated. The partition 301 is a partition that includes the system board 201 and the IOU 211 illustrated in FIG. 3. Furthermore, the partition 302 is a partition that includes the system board 202 and the IOU 212 illustrated in FIG. 3. Moreover, a free indicates the standby system 400 in FIG. 3. The configuring unit 14 sets “on” in a field corresponding to the system board and the IOU that constitute each partition or the free in a row thereof. For example, because the partition 301 is the partition including the system board 201 and the IOU 211, the configuring unit 14 sets “on” in a field 501 and a field 502 indicating the system board 201 and the IOU 211. Furthermore, in a row of each partition, the configuring unit 14 puts “R” in a field of a system board that is the reserved SB of a system board included in the partition. For example, because the system board 203 and the system board 204 are the reserved SB in the partition 301, the configuring unit 14 puts “R” in a field 503 and a field 504 indicating the system board 203 and the system board 204. Moreover, because in the standby system 400, the system board 203, the system board 204, the IOU 213 and the IOU 214 are included, the configuring unit 14 sets “on” in fields indicating the system board 203, the system board 204, the IOU 213 and the IOU 214. The configuring unit 14 stores the table 500 thus structured in the storage unit 15 as the partition configuration information 151.

Herein, one example of a rule of setting a partition configuration in the reserved SB function is explained. A first rule is to include at least one system board in a partition. A second rule is to include at least one IOU in a partition. In the present embodiment, a partition is configured in accordance with the above two rules.

Furthermore, one example of a rule of setting a reserved SB in the reserved SB function is explained. A first rule is that as for a reserved SB of a system board, any system board that does not belong to a partition to which the system board belongs can be set as the reserved SB. A second rule is that one reserved SB can be a reserved SB of more than one partition. A third rule is that more than one reserved SB can be set for a single partition. In the present embodiment, a reserved SB is set in accordance with the above three rules.

Explanation is continued returning back to FIG. 2. The switching unit 13 receives partition information and setting information of a reserved SB from the configuring unit 14. The switching unit 13 receives notification of detection of a failure from the monitoring unit 12 when a failure occurs in any of the system boards 200. The switching unit 13 separates the system board 200 in which a failure has occurred from the partition 300, and installs a reserved SB of the system board 200 in place thereof in the partition 300, to make a new partition 300 by the reserved SB function. At this time, the switching unit 13 reboots the partition 300 including the failed system board 200, and starts up with the configuration of the new partition 300. Although the switching unit 13 uses the information on the partition configuration and the setting of a reserved SB received from the configuring unit 14 to execute switching of system boards by the reserved SB function in the present embodiment, the switching unit 13 may use the partition configuration information 151.

As conditions for occurrence of switching of the system boards 200 by the reserve SB function, for example, there are three conditions as follows: when a system boards fails; when at least one of CPUs on system boards fails; and when at least one of memories on system boards fails. In the present embodiment, switching of system boards occurs under the three conditions described above.

Furthermore, as a rule of switching the system boards 200 by the reserved SB function, there is a rule as follows.

First, when one system board is set as a reserved SB of multiple partitions, and when more than one partition fails at the same time, the system board of a lower number is switched as priority. Suppose that partitions are numbered, and in the present embodiment, the reference numerals of the respective system boards in FIG. 3 correspond to system board numbers.

Moreover, a switching destination system board is determined by a method as follows. When more than on reserved SB is assigned for one partition, and if reserved SBs that do not belong to any of the partitions are present, a reserved SB having the largest SB number thereamong is used to for switching as priority. In the present embodiment, the system board numbers are used as the reserved SB numbers. Furthermore, when more than one reserved SB is assigned for one partition, and if only reserved SBs that have been installed in the partitions are present, a reserved SB having the largest reserved SB number among reserved SBs in partitions the powers of which are turned off is used for switching as priority. If only partitions the powers of which are one are present, a reserved SB having the largest reserved SB number thereamong is used for switching as priority.

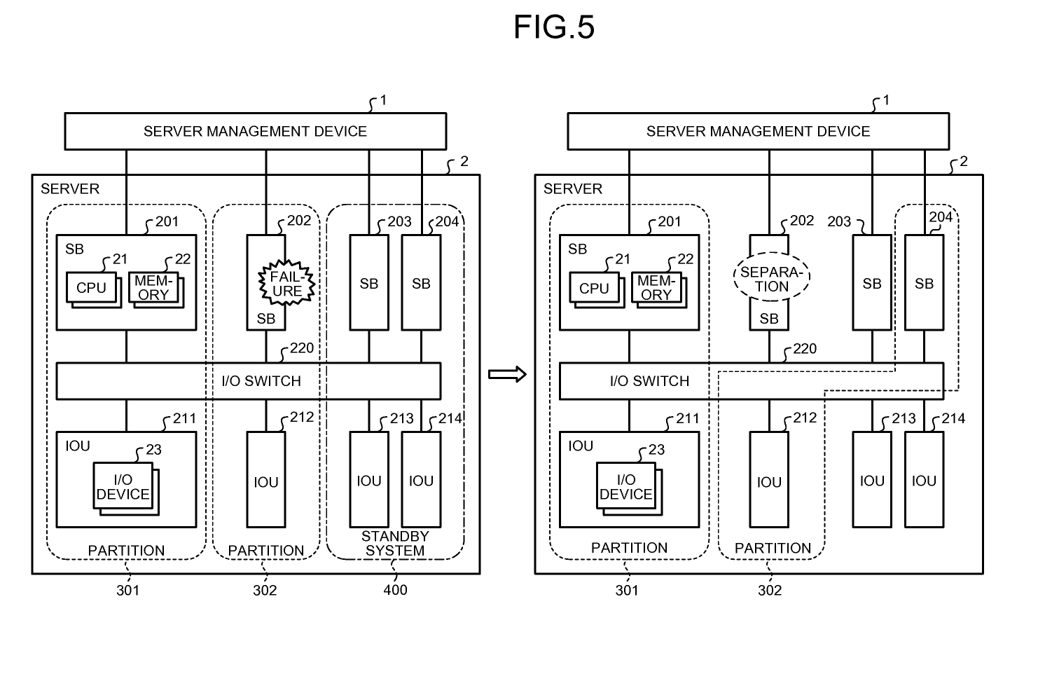

A case in which a failure has occurred in the system board 202 is explained referring to FIG. 5. FIG. 5 is a diagram for explaining system board switching by the reserved SB function. A left side of FIG. 5 depicts a state of the server 2 when a failure occurs, and a right side of FIG. 5 depicts a state of the server 2 after system board switching has been performed by the reserved SB function. When a failure occurs in the system board 202 as depicted on the right side of FIG. 5, the switching unit 13 shuts down the partition 302 once to reboot the partition 302. The switching unit 13 then cancels the configuration of the partition 302 once. Subsequently, the switching unit 13 determines that the system board 203 and the system board 204 are allocated to the system board 202 as reserved SBs thereof. Next, the switching unit 13 selects the system board 204 having a larger SB number out of the system board 203 and the system board 204 as a switching destination system board. The switching unit 13 then re-creates the partition 302 with the system board 204 and the IOU 212 as a set, and boots the partition 302.

Specifically, the switching unit 13 switches the I/O switch 220 to connect the system board 204 and the IOU 212, and instructs the system board 204 to use the I/O device 23 of the IOU 212, and causes them to boot. Thus, the system board 202 is separated therefrom, and the partition 302 is continued to be operated as a partition including the system board 204 and the IOU 212, as depicted on the right side of FIG. 5.

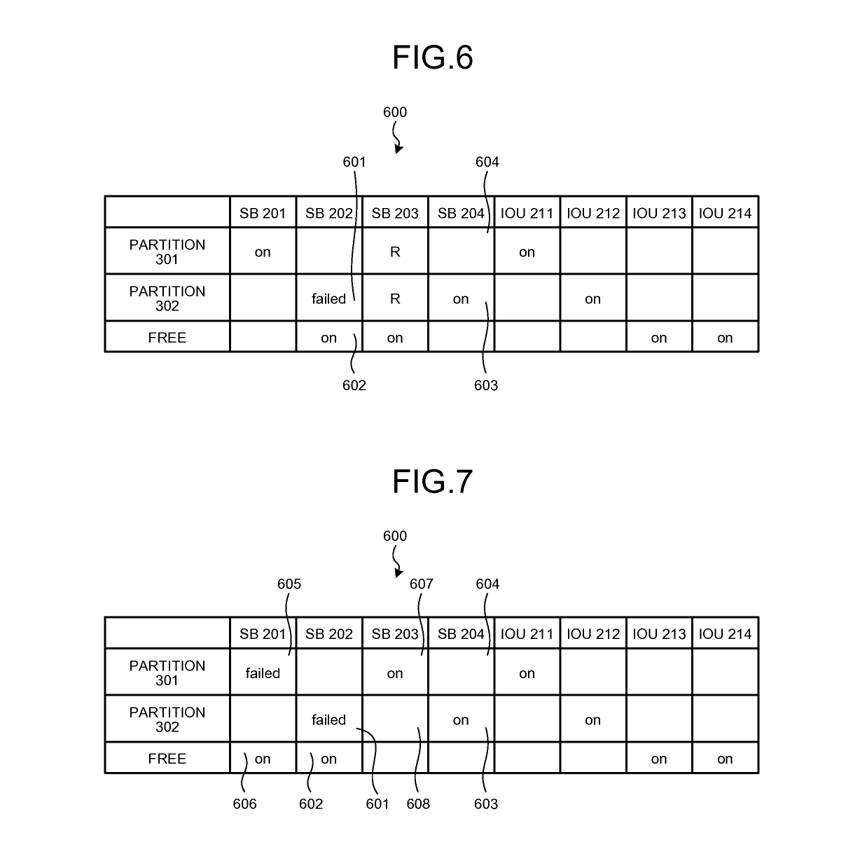

Moreover, the switching unit 13 checks the automatic recovery flag after changing the configuration of the partition 300 by switching of the system boards 200. When the automatic recovery flag is on, the switching unit 13 creates post-switch information 152 that is information indicating a state of each board after switching, and stores the created post-switch information 152 in the storage unit 15. The post-switch information 152 is stored, for example, in a form as a table 600 illustrated in FIG. 6. FIG. 6 illustrates one example of the post-switch information.

The post-switch information illustrated in FIG. 6 is explained. The switching unit 13 makes a copy of the partition configuration information 151 stored in the storage unit 15. The switching unit 13 then describes “failed” in a field of the system board 200 in which a failure has occurred in a row of the partition 300 including the system board 200 in which a failure has occurred in the copy of the post-switch information 152. Furthermore, the switching unit 13 puts “on” in a field corresponding to free of the system board 200 in which the failure has occurred. Moreover, the switching unit 13 puts “on” in a field of the system board 200 to be a destination of switching in a row of the partition 300 including the system board in which the failure has occurred. The switching unit 13 then deletes description “R” expressing allocation as a reserved SB for the system boards 200 other than the system board of the switching destination.

For example, explanation is given with a case in which a failure occurs in the system board 202 of the partition 302 and is switched to the system board 204. The switching unit 13 makes a copy of the table 500 in FIG. 4, and describes “failed” in a field 601 corresponding to the system board 202 of the partition 302. Furthermore, the switching unit 13 puts “on” in a field 602 corresponding to free of the system board 202. Moreover, the switching unit 13 puts “on” in a field 603 corresponding to the system board 204 of the partition 302 of the partition 302. Furthermore, the switching unit 13 deletes description in a field 604 corresponding to the partition 301 of the system board 204, and cancels allocation of the system board 204 as a reserved SB for the partition 301 and the partition 302. The switching unit 13 then stores the table 600 thus created in the storage unit 15 as the post-switch information 152.

The monitoring unit 12 monitors occurrence of a failure in the system boards 200. Moreover, the monitoring unit 12 monitors whether it has returned to a normal state by taking an action to a failure such as repair or replacement of the system board 200 in which the failure has occurred. Hereinafter, recovery to a normal state of the system board 200 in which a failure has occurred by taking an action to the failure is referred to as “failure recovery”.

When a failure occurs in the system board 200, the monitoring unit 12 sends information about the system board 200 in which a failure has occurred to the configuring unit 14 together with notification of the failure.

Furthermore, when failure recovery is achieved for the system board 200, the monitoring unit 12 transmits information of the system board 200 for which failure recovery has been achieved to the re-setting unit 11 together with notification of failure recovery.

The re-setting unit 11 receives the notification of failure recovery from the monitoring unit 12. The re-setting unit 11 then determines whether the automatic recovery flag is on in the storage unit 15.

When the automatic recovery flag is on, the re-setting unit 11 checks the post-switch information 152 stored in the storage unit 15. Subsequently, the re-setting unit 11 determines whether the system board 200 for which failure recovery is achieved is a system board that has been switched to a reserved SB by the reserve SB function, using the post-switch information 152. For example, the post-switch information 152 is in a format of the table 600 in FIG. 6, the re-setting unit 11 determines that the system board 200 is a system board switched to a reserved SB if there is a description as failed in the column of the system board 200 for which failure recovery is achieved. On the other hand, if there is no description as failed in the column of the system board 200 for which failure recovery is achieved, the re-setting unit 11 determines that the system board 200 is not a system board that has been switched to a reserved SB.

Next, when the system board 200 for which failure recovery is achieved is the system board that has been switched to a reserved SB, the re-setting unit 11 performs the following operation. The re-setting unit 11 deletes, form the post-switch information 152, information indicating that the system board 200 for which failure recovery is achieved is a system board that has been switched to a reserved SB. Specifically, the re-setting unit 11 deletes the description as failed from the column of the system board 200 for which failure recovery is achieved. Subsequently, the re-setting unit 11 determines whether a system board for which failure recovery is not achieved is present among other system boards 200 that have been switched to reserved SBs. Specifically, the re-setting unit 11 determines whether there is a system board for which description as failed is included in the post-switch information 152. When there is no system board for which description as failed is included, the re-setting unit 11 determines that failure recovery is achieved for all of the system boards 200 that have been switched to reserved SBs.

When failure recovery is achieved for all of the system boards 200 that have been switched to reserved SBs, the re-setting unit 11 acquires configuration information before switching to a reserved SB from the partition configuration information 151. The re-setting unit 11 reconfigures the system board 200, the I/O switch 220, and the IOU 210 so as to obtain the acquired partition configuration and setting of a reserved SB. Thus, the partition configuration of the server 2 and the setting of a reserved SB are recovered to a state before the switching of the system boards to reserved SBs is performed.

On the other hand, when a system board for which failure recovery is not achieved is present among other system boards 200 that have been switched to reserved SBs, the re-setting unit 11 waits until failure recovery of the rest of the system board 200 that have been switched to reserved SBs is achieved. That is, recovery to a state before the switching of the system board to the reserved SB is not performed, and operation of the partition 300 in which switching to the reserved SB has been performed is continued as it is.

After performing partition configuration and setting of a reserved SB, the re-setting unit 11 deletes the post-switch information 152. In configuration of a partition configuration and setting of a reserved SB, the re-setting unit 11 reboots the partition 300 to be reconfigured.

For example, if the post-switch information 152 is in a state of the table 600 in FIG. 6, when failure recovery of the system board 202 is achieved, the re-setting unit 11 deletes the description as failed in the field 601. In this case, because no other descriptions as failed are present, the re-setting unit 11 determines that failure recovery of all of the system boards 200 that have been switched to reserved SBs is achieved. The re-setting unit 11 then refers to the table 500 in FIG. 4, and separates the system board 204 from the partition 302, and reconfigures the partition 302 with the system board 202 and the IOU 212. Furthermore, the re-setting unit 11 re-sets the system board 204 as a reserved SB of the partition 301 and the partition 302.

Although explanation has been given with a case in which a failure occurs only in the system board 202 in the above, it can be considered that occurrence of a failure in more than one system board by a failure occurring in another system board before failure recovery is achieved. Therefore, operation when a failure occurs in more than one system board is explained. For example, explanation is given in a case in which another failure occurs in the system board 201 in a state in which a failure has occurred in the system board 202 to be in the state expressed in the table 600 in the FIG. 6.

In this case, the switching unit 13 corrects the table 600 in FIG. 6 to that as illustrated in FIG. 7. FIG. 7 illustrates one example of post-switch information when a failure occurs in two system boards. The switching unit 13 describes “failed” in a field 605 of the system board 201 of the partition 301 as indicated in the table 600 in FIG. 7. Furthermore, the switching unit 13 puts “on” in a field 606 of free of the system board 201. Moreover, the switching unit 13 puts “on” in a field 607 of the system board 203 of the partition 301. Moreover, the switching unit 13 deletes description in a field 608 corresponding to the partition 302 of the system board 203, and cancels the allocation of the system board 203 to the partition 301 and the partition 302 as a reserved SB. The switching unit 13 then stores the table 600 in FIG. 7 thus created in the storage unit 15 as the post-switch information 152.

When failure recovery of the system board 200 is achieved when the post-switch information 152 is in a state expressed in the table 600 in FIG. 7, the re-setting unit 11 deletes the description as failed of the system board 202 from the table 600. However, the description as failed of the system board 201 is still remaining. Therefore, the re-setting unit 11 waits until failure recovery of the system board 201 is achieved. That is, the system board 202 is not installed in the partition 302, and operation is continued in a state in which the system board 204 and the IOU 212 are included. Thereafter, when failure recovery of the system board 201 is achieved, the re-setting unit 11 deletes the description as failed of the system board 201 from the table 600. Thus, descriptions as failed are all cleared from the table 600, and it is regarded that failure recovery is achieved for all of the system boards that have been switched to reserved SBs. In this state, the re-setting unit 11 refers to the table 500 in FIG. 4, separates the system board 204 from the partition 302, and reconfigures the partition 302 with the system board 202 and the IOU 212. Moreover, the re-setting unit 11 separates the system board 203 from the partition 301, and reconfigures the partition 301 with the system board 201 and the IOU 211. Furthermore, the re-setting unit 11 re-sets the system board 203 and the system board 204 as a reserved SB of the partition 301 and the partition 302.

As described, the server management device 1 according to the present embodiment restores a partition configuration and setting of a reserved SB, after failure recovery of all of system boards that have been switched to reserved SBs is achieved.

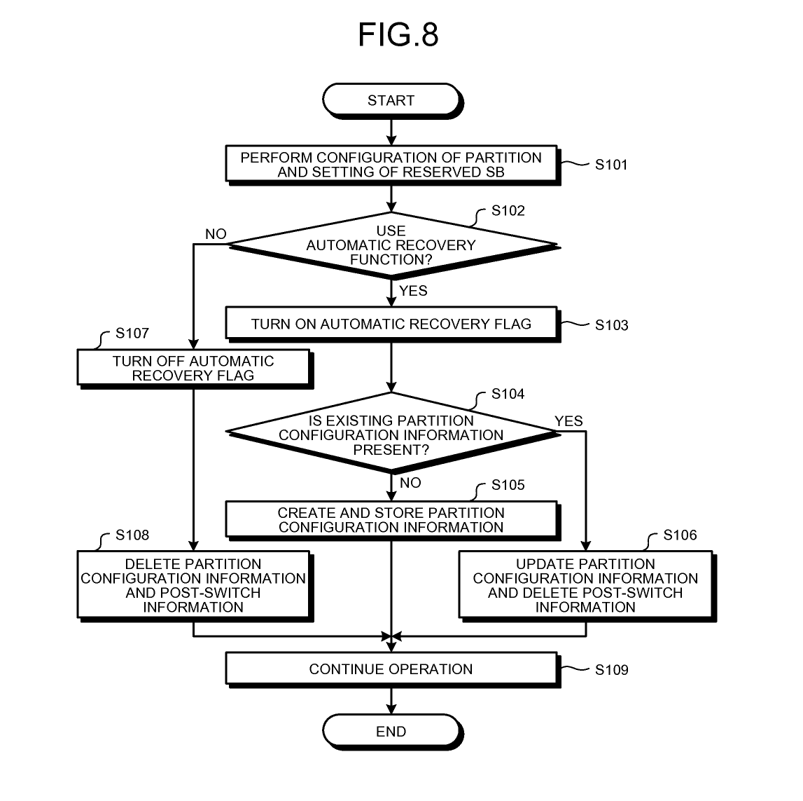

Next, a flow of configuration of a partition and setting of a reserved SB in the information processing system according to the present embodiment is explained referring to FIG. 8. FIG. 8 is a flowchart of configuration of a partition and setting of a reserved SB in the information processing system according to the present embodiment.

The configuring unit 14 performs configuration of a partition and setting of a reserved SB according to an input by an administrator (step S101).

Subsequently, the configuring unit 14 determines whether to use an automatic recovery function based on the input by the administrator (step S102).

When the automatic recovery function is used (step S102: YES), the configuring unit 14 turns on the automatic recovery flag (step S103).

Subsequently, the configuring unit 14 determines whether the partition configuration information 151 already existing is stored in the storage unit 15 (step S104). When the partition configuration information 151 is not present (step S104: NO), the configuring unit 14 creates the partition configuration information 151 and stores in the storage unit 15 (step S105)

On the other hand, when the partition configuration information 151 already existing is present (step S104: YES), the configuring unit 14 updates the partition configuration information 151 to the configuration instructed by the administrator. Furthermore. when the post-switch information 152 is stored in the storage unit 15, the configuring unit 14 deletes the post-switch information 152 (step S106).

On the other hand, when the automatic recovery function is not used (step S102: NO), the configuring unit 14 turns off the automatic recovery flag (step S107). Subsequently, if the partition configuration information 151 or the post-switch information 152 is stored in the storage unit 15, the configuring unit 14 deletes it (step S108).

Thereafter, the server 2 continues operation with the set partition configuration (step S109).

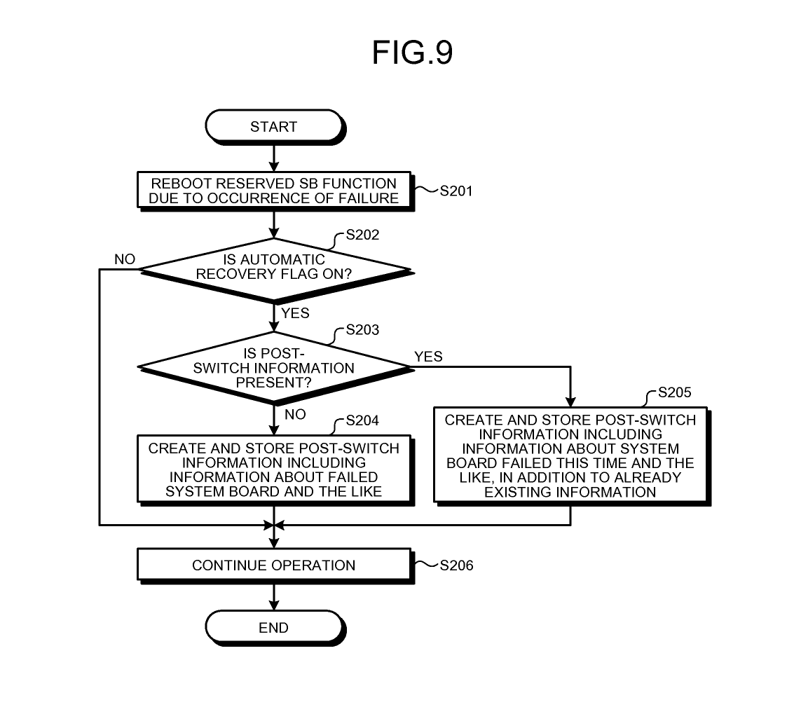

Next, a flow of processing of the reserved SB function in the information processing system according to the present embodiment is explained referring to FIG. 9. FIG. 9 is a flowchart of the processing of the reserved SB function in the information processing system according to the embodiment.

Receiving notification of occurrence of a failure from the monitoring unit 12, the switching unit 13 uses the reserved SB function to change a configuration of the partition 300 that includes the system board 200 in which the failure has occurred, and reboots the partition 300 (step S201). At this time, the switching unit 13 switches the system board 200 in which the failure has occurred to a corresponding reserved SB, using the reserved SB function.

The switching unit 13 then determines whether the automatic recovery flag is on (step S202). When the automatic recovery flag is off (step S202: NO), the server 2 proceeds to step S206.

On the other hand, when the automatic recovery flag is on (step S202: YES), the switching unit 13 determines whether the post-switch information 152 is already present in the storage unit 15 (step S203). When the post-switch information 152 is not present (step S203: NO), the switching unit 13 creates the post-switch information 152 including information about the reserved SB of the switching destination of the system board 200 in which the failure has occurred, and stores the created post-switch information 152 in the storage unit 15 (step S204).

On the other hand, when the post-switch information 152 is already present (step S203: YES), the switching unit 13 creates the post-switch information 152 including information about the system board 200 in which the failure has occurred this time and the reserved SB of the switching destination, and stores the created post-switch information 152 in the storage unit 15 in addition to information already existing (step S205).

Thereafter, the server 2 continues operation with the partition configuration in which the system boards are switched by the reserved SB function (step S206).

FIG. 9 indicates a series of processing that is performed when failure recovery is performed, and when failure recovery is performed several times, the processing indicated in a flow in FIG. 9 is performed each time.

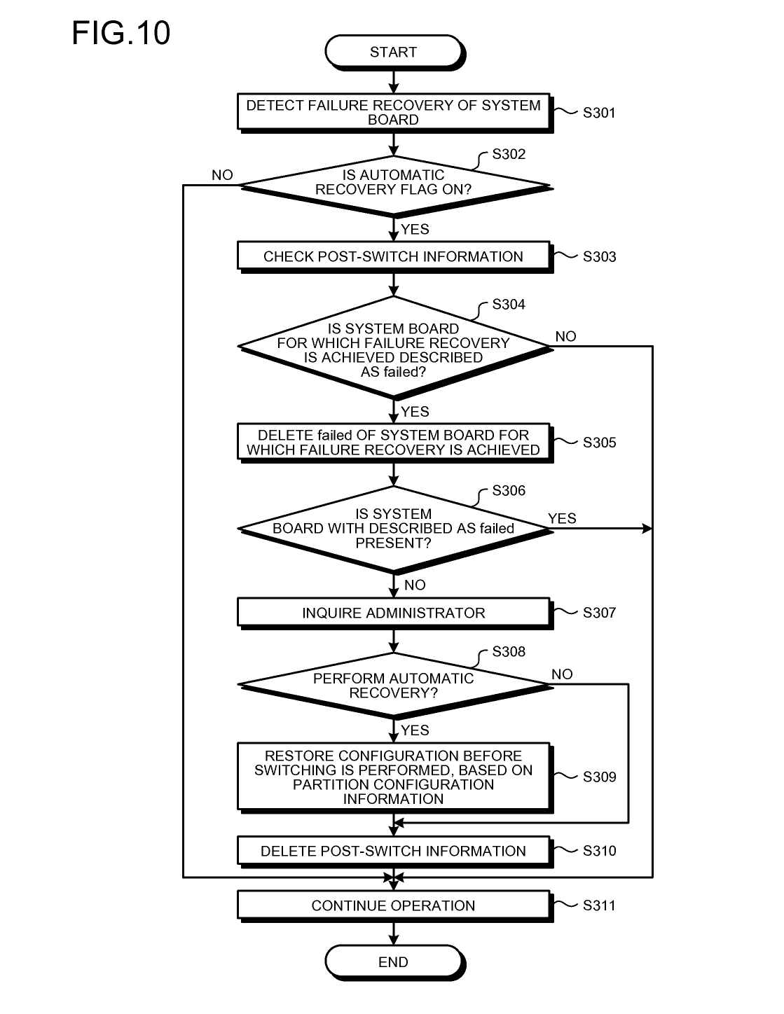

Next, a flow of processing at the time of failure recovery in the information processing system according to the present embodiment is explained, referring to FIG. 10. FIG. 10 is a flowchart of the processing in failure recovery in the information processing system according to the embodiment.

The monitoring unit 12 detects failure recovery of the system board 200 (step S301). The monitoring unit 12 notifies the failure recovery to the re-setting unit 11.

The re-setting unit 11 determines whether the automatic recovery flag is on (step S302). When the automatic recovery flag is off (step S302: NO), the server 2 proceeds to step S311.

On the other hand, when the automatic recovery flag is on (step S302: YES), the re-setting unit 11 checks the post-switch information 152 stored in the storage unit 15 (step S303). The re-setting unit 11 then determines whether the system board for which failure recovery is achieved is “failed”, that is, whether it is the system board 200 that has been switched to a reserved SB (step S304). When the system board for which failure recovery is achieved is not failed (step S304: NO), the server 2 proceeds to step S311.

On the other hand, when the system board 200 for which failure recovery is achieved is failed (step S304: YES), the re-setting unit 11 deletes failed in the post-switch information 152 of the system board 200 for which failure recovery is achieved (step S305).

Subsequently, the re-setting unit 11 determines whether a system board described as failed is present in the post-switch information 152 (step S306). When a system board described as failed is present (step S306: YES), the server 2 proceeds to step S311.

On the other hand, when a system board described as failed is not present (step S306: NO), the re-setting unit 11 inquires the administrator whether to perform the automatic recovery (step S307). For example, the re-setting unit 11 causes a monitor of the server 2 or the like to display a message to inquire whether to perform the automatic recovery.

Receiving an instruction from the administrator, the re-setting unit 11 determines whether to perform the automatic recovery (step S308). When the automatic recovery is not performed (step S308: NO), the re-setting unit 11 proceeds to step S310.

On the other hand, when the automatic recovery is performed (step S308: YES), the re-setting unit 11 restores the partition configuration before performing the system board switching by the reserved SB function, using the partition configuration information 151 (step S309).

Thereafter, the re-setting unit 11 deletes the post-switch information 152 from the storage unit 15 (step S310).

The server 2 continues operation with the partition configuration at this moment (step S311).

As explained above, the server management device according to the present embodiment can recover to a partition configuration to a state before occurrence of a failure when failure recovery of a system board in which a failure has occurred is achieved after the reserved SB function operates and a partition configuration thereof changes. That is, the server management device according to the present embodiment can automatically restore a configuration of an operation policy that has initially been set. Thus, a work of an administrator to restore a configuration of a partition to a state before occurrence of a failure can be reduced, and a configuration of a partition can be recovered accurately reducing a human error.

Moreover, in the above explanation, restoring a configuration of a partition is performed after failure recovery is achieved for failed system boards in all of partitions in which switching to reserved SBs has been executed. Meanwhile, as another method, a configuration may be restored per partition in which failure recovery for a system board is completed. For example, in FIG. 3, in a state in which failures occur in both of the partition 301 and the partition 302, only the partition 302 may be restored to a state before occurrence of the failure when replacement of a system board of the partition 302 is done. In this case, the configuring unit 14 sequentially stores the partition information each time a failure occurs, and when failure recovery of the system board is achieved, processing of restoring a configuration of the partition may be performed using the partition information at the time of occurrence of a corresponding failure.

Hardware Configuration

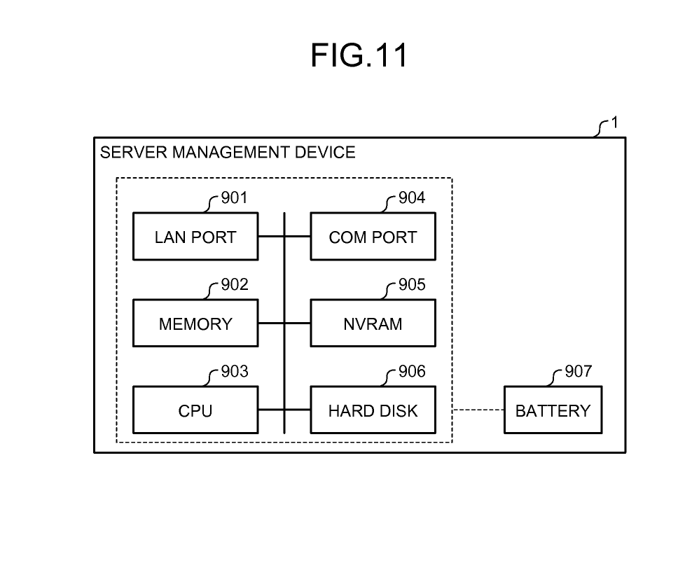

Next, a hardware configuration of the server management device 1 is explained referring to FIG. 11. FIG. 11 is a hardware configuration diagram of the server management device.

The server management device 1 includes a local area network (LAN) port 901, a memory 902, a CPU 903, a communication (COM) port 904, a NVRAM 905, a hard disk 906, and a battery 907.

The battery 907 supplies power to the NVRAM 905.

The LAN port 901, the memory 902, the COM port 904, and the NVRAM 905 are connected to the CPU 903 through a bus.

The LAN port 901 is a network interface, and is connected to the server 2 through a network cable. The server management device 1 performs communication of information with the server 2 through the LAN port 901.

The COM port 904 is an interface to connect a scanner, a modem, and the like.

The NVRAM 905 is a non-volatile RAM, and implements a function of the storage unit 15 and the like illustrated in FIG. 2.

The CPU 903, the memory 902, and the hard disk 906 implement functions of the re-setting unit 11, the monitoring unit 12, and the configuring unit 14 illustrated in FIG. 2, and the like.

Specifically, the hard disk 906 stores various kinds of programs such as a program to implement functions of the re-setting unit 11, the monitoring unit 12, the switching unit 13, the configuring unit 14, and the like. The CPU 903 reads various kinds of programs from the hard disk 906, develops on the memory 902, and generates processes to implement each function described above.

According to one aspect of an information processing apparatus, a control method for an information processing apparatus, and a computer-readable recording medium for controlling an information processing apparatus disclosed in the present application, an effect that a system having partitions can be automatically restored to a configuration before occurrence of a failure is produced.

All examples and conditional language recited herein are intended for pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. An information processing apparatus comprising:
a configuring unit that performs configuration of a partition and allocation of a reserved system board to the partition, the partition being a set of a system board equipped with a central processing unit and a memory, and an input/output unit equipped with an input/output device that are installed in one package;
a switching unit that switches, when a failed system board in which a failure has occurred is present, the failed system board to a reserved system board that is allocated to a partition including the failed system board; and
a re-setting unit that resets, when the failed system board is recovered after switching of system boards have been performed by the switching unit, the configuration of the partition and the allocation of the reserved system board based on information of the configuration of the partition and the allocation of the reserved system board made by the configuring unit.

2. The information processing apparatus according to claim 1, wherein
the configuring unit creates first information that indicates the configuration of the partition and the allocation of the reserved system board made by the configuring unit,
the switching unit creates second information that indicates correspondence between the failed system board and the reserved system board to be a switching destination, and
the re-setting unit refers to the second information when the failed system board is recovered, and re-sets the configuration of the partition and the allocation of the reserved system board based on the first information when the failed system board recovered has once been switched to the reserved system board.

3. The information processing apparatus according to claim 2, wherein
the re-setting unit re-sets the configuration of the partition and the allocation of the reserved system board based on the first information when determining that the failed system board recovered has once been switched to the reserved system board, and when no other failed system boards that have been switched to the reserved system board but have not been recovered are present, by referring to the second information.

4. A control method for an information processing apparatus, comprising:
making initial setting of configuration of a partition and allocation of a reserved system board to the partition, the partition being a set of a system board equipped with a central processing unit and a memory, and an input/output unit equipped with an input/output device that are installed in one package;
switching, when a failed system board in which a failure has occurred is present, the failed system board to a reserved system board that is allocated to a partition including the failed system board; and
re-setting, when the failed system board is recovered after switching of system boards have been performed, the configuration of the partition and the allocation of the reserved system board based on information of the initial setting.

5. A computer-readable recording medium having stored therein a program that causes a computer to execute:
making initial setting of configuration of a partition and allocation of a reserved system board to the partition, the partition being a set of a system board equipped with a central processing unit and a memory, and an input/output unit equipped with an input/output device that are installed in one package;
switching, when a failed system board in which a failure has occurred is present, the failed system board to a reserved system board that is allocated to a partition including the failed system board; and
re-setting, when the failed system board is recovered after switching of system boards have been performed, the configuration of the partition and the allocation of the reserved system board based on information of the initial setting.
